(19) United States
(12) Patent Application Publication
(10) Pub. No.: US 2004/0082479 A1
(43) Pub. Date: Apr. 29, 2004

(54) Method for soil sterilization from pathogens

(76) Inventors: David Mirelman, Ramat Efal (IL); Miriam Abramski, Rehovot (IL); Ilan Chet, Ness Ziona (IL); Talia Miron, Kfar Haim (IL); Aharon Rabinkov, Rehovot (IL); Meir Wilchek, Rehovot (IL)

Correspondence Address: BROWDY AND NEIMARK, P.L.L.C., 624 NINTH STREET, NW, SUITE 300, WASHINGTON, DC, 20001-5303, US

(21) Appl. No.: 10/466,431

(22) PCT Filed: Jan. 17, 2002
(86) PCT No.: PCT/US02/01204

(30) Foreign Application Priority Data
Jan. 17, 2001 (IL) 140948

(51) Int. Cl. A01N 31/00

(52) U.S. Cl. 504/349

(57) ABSTRACT

Allicin is administered to soil prior to seeding or planting in order to protect the plants against pathogenic organisms, such as fungi, bacteria, protozoa and soil nematodes.

### FIELD OF THE INVENTION

The present invention relates to the field of agriculture and, more particularly, to a method for sterilization of soil in limited areas using allicin. The allicin is administered to the soil prior to seeding or planting and protects the plants against pathogenic organisms.

### BACKGROUND OF THE INVENTION

Treatment of soil with agents that kill microorganisms prior to the seeding or planting of high value plants is a well established procedure in modern and intensive agriculture.

The most commonly used agent to treat soil in greenhouses and limited open air areas is methyl bromide, a broad spectrum pesticide used in the control of pest insects, nematodes, weeds, pathogens, and rodents (Katan, 1999). In the U.S., about 21,000 tons of methyl bromide are used annually in agriculture, primarily for soil fumigation (85%), as well as for commodity and quarantine treatment (10%), and structural fumigation (5%). Globally, about 72,000 tons are used each year.

Methyl bromide, a colorless and odorless gas at normal temperatures and pressures, is a toxic material and affects the target pests as well as non-target organisms. When used as a soil fumigant, it dissipates rapidly to the atmosphere and is very dangerous at the actual fumigation site. Human exposure to, particularly inhalation of, methyl bromide can cause dizziness, headache, nausea, vomiting, abdominal pain, mental confusion, tremors, convulsions, pulmonary edema, coma as well severe deleterious actions on the lungs, eyes, and skin. Chronic exposure to methyl bromide can result in central nervous system depression, respiratory system failure, and kidney injury.

About 50 to 95% of the methyl bromide injected into the soil can eventually enter the atmosphere. In addition, methyl bromide is known as a major source of atmospheric bromine radicals which destroy the stratospheric ozone layer. Due to this well documented hazard and damages induced by methyl bromide, there has been considerable concern against the use of this pesticide and it will be banned from use in the year 2005.

There is an urgent need to provide materials that can substitute methyl bromide in pest control in the agricultural production system. It is critical to provide alternatives that can both control all pests which may reduce crop yield or quality and be available to growers from economic and regulatory perspectives.

### SUMMARY OF THE INVENTION

The present invention relates to the use of allicin (thio-2-propene-1-sulfinic acid S-allyl ester) for sterilization of soil prior to seeding and planting. Thus, allicin can be used in a method for protecting plants against contamination by plant pathogens such as fungi, bacteria, protozoa and soil nematodes, which method comprises seeding or planting the plants in soil that was previously treated with allicin. The method is particularly useful for use in greenhouses.

### BRIEF DESCRIPTION OF THE DRAWINGS

FIG. 1 is a graph depicting the development of diseased bean plants growing in soil preinfected by Rhizoctonia solani that was pre-treated with different amounts of allicin under greenhouse conditions prior to seeding of the bean plants: A-0.31 mg /ml; B-0.62 mg/ml; C-0.94 mg/ml; D-1.25 mg/ml allicin. Results are expressed as % of diseased bean plants. First cycle (black columns): 14 days after planting; second cycle (gray columns): 14 days after replanting bean plants as described in Example 2 herein.

FIG. 2 is a graph depicting the same experiment as in FIG. 1 but wherein the results are expressed as % of reduction of diseased bean plants.

FIG. 3 is a photograph of the basal stem of diseased bean plants at the end of the first cycle (two weeks after seeding) according to experiment as in FIG. 1 showing the effect of the different concentrations of allicin. The brown spots are the location of the disease.

### DETAILED DESCRIPTION OF THE INVENTION

Allicin, one of the biologically active molecules that is rapidly generated upon crushing of garlic cloves, has been shown to have potent wide range antimicrobial effects at low concentrations (Lawson, 1998) and is here presented as an alternative to the use of methyl bromide.

Allicin (thio-2-propene-1-sulfinic acid S-allyl ester) is a chemically unstable, colorless liquid that has shown to be responsible for both the odor and much of the biological activity and the beneficial properties ascribed to garlic. Thus, allicin presents remarkable antibiotic activity including antibacterial activity against a wide range of Gram-negative. and Gram-positive, aerobic and anaerobic, bacteria, as well as antifungal, antiprotozoal, antiviral, antiparasitic and insecticidal activities (Amer et al, 1980; Amonkar et al, 1971; Amonkar et al, 1970; Appleton et al, 1975; Barone et al, 1977; Fromtling et al, 1978; Mirelman et al., 1987; et al, 1977; Tansey et al, 1975].

Allicin is a very labile and volatile compound when exposed to air and many of the methods known today for its preparation are not satisfactory. The chemical synthesis involves many steps and is complicated, laborious, expensive, and very inefficient. The enzymatic method seems to be more attractive; however, alliinase is a so-called “suicidal enzyme” that is rapidly and irreversibly inactivated by its own reaction product, allicin. Therefore, a few minutes incubation of alliinase with the substrate alliin or its product, allicin, leads to a biologically inactive enzyme after one or a very limited number of cycles. This problem has been solved recently by the present inventors through the procedure described in International PCT Publication No. WO 97/39115 (Mirelman et al, 1997) whereby the enzyme alliinase is chemically, physically or biologically immobilized and large amounts of substantially pure allicin in aqueous solution can be continuously produced by a method which comprises adding the substrate alliin to a column containing the immobilized alliinase.

According to the present invention, it was investigated and found that allicin may be used to disinfect soil prior to seeding or planting of plants, thus enabling the improved, disease-free growth of certain high value plants, and being a good candidate to replace methyl bromide in its agricultural use.

The present invention thus provides, in one aspect, a method for sterilization of soil against plant pathogens which comprises administering to the soil an effective amount of allicin prior to seeding and planting. The plant pathogen may be any of the plant pathogenic fungi, bacteria and protozoa. Furthermore, it has recently been discovered that allicin can also inactivate soil nematodes (small worms).

In one embodiment, allicin is used to protect plants against plant pathogenic fungi such as, but not being limited to, fungi of the genera Sclerotinia, Fusarium, Rhizoctonia, Sclerotium rolfsii and Trichoderma that attack mushroom. In particular, allicin may be used against fungus of the genera Rhizoctonia such as Rhizoctonia solani.

Allicin can be administered to the soil in any suitable manner, preferably by irrigation. Its use is more suitable to limited areas and, more particularly, in greenhouses.

According to the invention, plants are protected against contamination by plant pathogens when the soil is treated with allicin prior to seeding or planting. Preferably, the plants should be seeded or planted about 8 days after treatment of the soil with allicin.

The accepted rule of thumb for soil surface sterilization or fumigation is that administration of the fumigant or sterilant is calculated to treat the soil to a depth of 10-12 cm. Since the specific gravity of soil is about 1.5 g/cc, there is about 150-200 kg of soil in a square meter. The preferred amount of allicin is about 15-100 mg/kg soil, or 2.25-20 g/m² of soil surface area. Preferably, the amount is greater than 60 mg/kg soil. This amount is preferably included in the irrigation water. While a preferred practical maximum is given, it should be understood that there is no theoretical maximum as allicin is a non-toxic plant product.

The results obtained according to the invention clearly demonstrate that treatment of fungi-infected soil by irrigation with a solution of allicin can be a very effective method for soil decontamination. Allicin has been shown to have a wide range of antimicrobial activities and it could protect plants growing in allicin-treated soil against a myriad of disease-causing pathogens. The procedure to disinfect soil with allicin in aqueous solutions is simple and straightforward. The advantage of using allicin is that the molecule is a natural plant product and as such has no toxicity whatsoever to the plants or mammals which will later consume such plants. Thus, allicin, which is an environmentally friendly product that is now easy and cheap to produce, may offer an alternative to other soil sterilizing agents.

The invention will be now illustrated in a non-limiting manner by the following Examples.

### EXAMPLES

### Material and Methods

Pure allicin in aqueous solution at 2 mg/ml was obtained as previously described in International PCT Publication WO 97/39115, following the interaction of synthetic, nature-identical alliin (allylcysteine sulfoxide) with a preparation of stabilized garlic alliinase. Fungal plant pathogens were grown in soil as previously described (Ko et al, 1971). Contamination of soil with Rhizoctonia solani and infection of bean seedlings was determined as previously reported (Chet, 1987).

### Example 1

### Activity of Allicin against Plant Fungal Pathogens In Vitro

The effect of allicin on the growth of a number of known soil fungal pathogens was examined in vitro. Fungi were innoculated in Petri dishes containing potato dextrose agar (PDA, Difco) and the radial growth rate of the fungi was measured every 24 hours. The effect of the addition of 0.1 ml of a solution of allicin (2.0 mg/ml) on the radial growth rate of the pathogen was determined after 24, 48, 72 and 96 hours.

The results are shown in Table 1. Very significant inhibition of growth was noted for the following plant pathogens: Sclerotinia sclerotiorum, Fusarium oxysporum f. sp. vasinfectum, Rhizoctonia solani Kuhn, Scierotium rolfsii Sacc. and Trichoderma hurzianum. The substrate alliin had no effect on any of the fungi (not shown).

TABLE 1
Linear Growth of Different Fungi In Vitro with (a) and without
(c) Allicin (0.1 ml Allicin Solution 2 mg/ml)
Results: mm Radius of Growth

| | | 24 hrs | 48 hrs | 72 hrs | 96 hrs |
|---|---|---|---|---|---|
| (c) | Sclerotinia sclerotiorum | 16.5 | 35 | 45 | |
| (a) | Sclerotinia sclerotiorum | 0.5 | 7.5 | 20 | 45 |
| (c) | Fusarium oxysporum f. sp. | 6 | 12.5 | 22.5 | 25 |
| | Vasinfectum | | | | |
| (a) | Fusarium oxysporum f. sp. | 2.5 | 7.5 | 12.5 | 15 |
| | Vasinfectum | | | | |
| (c) | Rhizoctonia solani Kuhn | 16.5 | 35 | 45 | |
| (a) | Rhizoctonia solani Kuhn | 2.5 | 7.5 | 15 | |
| (C) | Sclerotium Rolfsii Sacc. | 11.5 | 30 | 45 | |
| (a) | Sclerotium Rolfsii Sacc. | 0 | 2.5 | 15 | |
| (c) | Trichoderma hurzianum | 12.5 | 32.5 | 45 | |
| (a) | Trichoderma hurzianum | 2.5 | 7.5 | 22.5 | |

### Example 2

### Effect of Allicin against Plant Fungal Pathogens In Vivo

In view of the fact that allicin exhibited significant growth inhibitory effects on Rhizoctonia solani (Table 1), an in vivo experiment was designed to study the effect of allicin in various concentrations to inhibit growth of this pathogen known to cause a well documented disease in more than 100 plants.

Boxes with raw red-brown, sandy loam soil (0.5 Kg) 1.0 were precontaminated with viable Rhizoctonia solani. The fungi-contaminated soil in the boxes were subsequently irrigated with aqueous solutions (30 ml/box) containing different concentrations of allicin (A: 0.31 mg allicin/ml; B: 0.62 mg allicin/ml; C: 0.94 mg allicin/ml; D: 1.25 mg allicin/ml). Irrigations were repeated 3 times, with 3 days intervals between treatments. Controls were irrigated with similar volumes of water. Four soil replicates were irrigated for each allicin concentration as well as for the control. Following each irrigation step, the soil boxes were closed in nylon bags. Four days after the last irrigation, the bags were opened and the boxes with the soil ventilated for 5 more days.

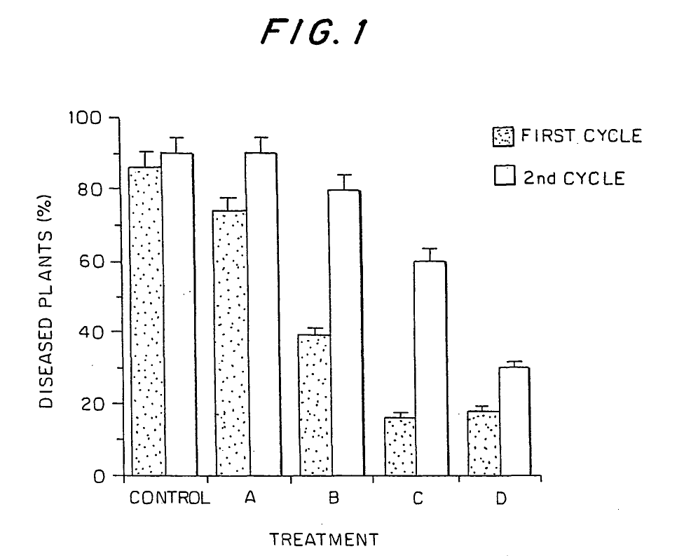

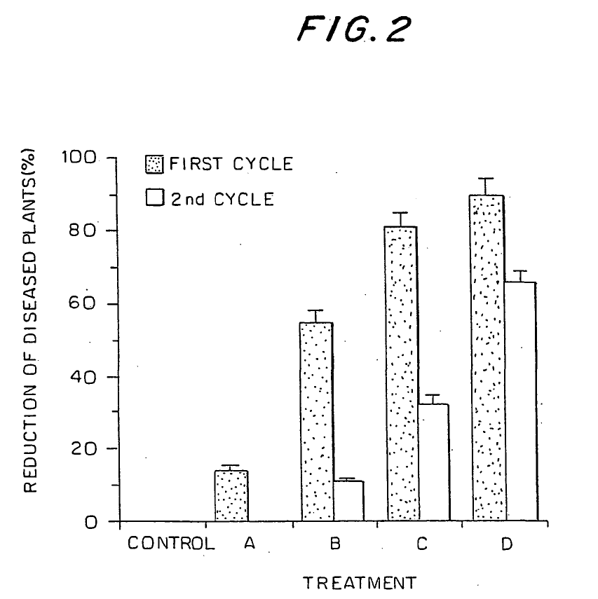

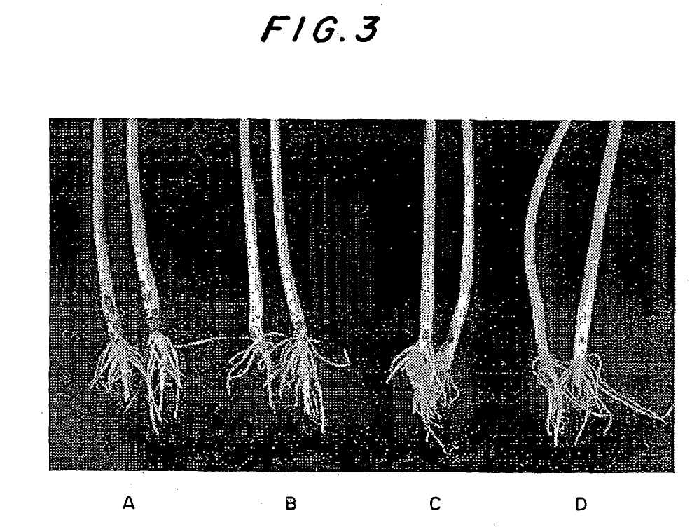

Bean seeds (Phaseolus vulgaris L.) (10/box) were then planted in each of the boxes and the growth and development of disease in the plants was determined after 14 days. The results are shown in Table 2 and in FIGS. 1-2. As shown in Table 2 and FIGS. 1-2, black columns, 86% of the control plants became diseased whereas in soil pre-irrigated with 0.94 (FIGS. 1-2, C) and 1.25 (FIGS. 1-2, D) mg/ml allicin, less than 20% of the plants became diseased (decrease of >80% in diseased plants, FIG. 2). The effect of allicin was dose-dependent and at the lowest concentration tested (0.31 mg allicin/ml), the decrease in the number of diseased plants was only 14% (Table 2 and FIGS. 1-2, black columns). FIG. 3 shows pictures of development of the disease in the basal stems of the plants at the end of 14 days (first cycle) after treatment of the soil with the various concentrations of allicin.

In order to test the time length efficacy of soil that was pre-treated with allicin, an additional experiment was done in the same soil boxes. After the first cycle of the bean growth experiment for 14 days described above, the plants were removed and a second cycle of bean growth was conducted whereby a new set of bean seeds was immediately seeded in the same soil boxes and the development of disease in the plants grown in this second cycle was determined after 14 days. The results are shown in Table 2 and in FIGS. 1-2, gray columns. Soil that had been pre-irrigated before the first cycle with the highest concentration of allicin (D, 1.25 mg/ml) was still capable of very significantly reducing disease and only 30% of the plants were infected. Some protection (33%) was also observed in soils irrigated with 0.94 mg allicin/ml (C). At lower concentrations in the second cycle the number of diseased plants was almost identical to that of the controls.

The above experiments demonstrate that plants can develop well in soil that had been contaminated with Rhizoctonia and which was then irrigated with allicin at concentrations of >1 mg/ml/0.5 Kg soil.

TABLE 2
Effect of Rhizoctonia solani Contaminated Soil Pre-Treated with
Various Concentrations of Allicin on the level of Diseased Bean
Plants

| | First Cycle | | Second Cycle | |
|---|---|---|---|---|
| | Diseased | Diseased | Diseased | Diseased |
| Treatment | Plants (%) | Reduction (%) | Plants (%) | Reduction (%) |
| control | 86 | | 90 | |
| A | 74 | 14 | 90 | 0 |
| B | 39 | 55 | 80 | 11 |
| C | 16 | 81 | 60 | 33 |
| D | 18 | 90 | 30 | 66 |

Control: water irrigation (30 ml)

A: 0.31 mg allicin/ml (30 ml)

B: 0.62 mg allicin/ml (30 ml)

C: 0.94 mg allicin/ml (30 ml)

D: 1.25 mg allicin/ml (30 ml)

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety-of alternative forms without departing from the invention. Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

### REFERENCES

Amer et al, “The effect of aqueous garlic extract on the growth of dermatophytes”, Int J Dermatol 19:285-287 (1980)

Amonkar et al, “Mosquito control with active principle of garlic, Allium sativum”, J Econ Entomol 63:1172-1175 (1970)

Amonkar et al, “Isolation and characterization of larvicidal principle of garlic”, Science 174:1343-1344 (1971)

Appleton et al, “Inhibition of growth of zoopathogenic fungi by garlic extract”, Mycologia 67:882-885 (1975)

Barone et al, “Isolation, purification, identification, synthesis, and kinetics of activity of the anticandidal component of Allium Sativum, and a hypothesis for its mode of action”, Mycologia 69:793-825 (1977)

Chet I, Innovative Approaches to Plant Disease Control, John Wiley & Sons, Inc., New York (1987)

Fromtling et al, “In vitro effect of aqueous extract of garlic (Allium sativum) on the growth and viability of Cryptococcus neoformans”, Mycologia 70:397-405 (1978)

Katan J, “The methyl bromide issue: Problems and potential solutions”, J of Plant Pathology 81:153-159 (1999)

Ko et al, “A selective media for the quantitative determination of Rhizoctonia solani in soil”, Phytopathology 61:707-710 (1971)

Lawson. L D, in Phytomedicines of Europe: Their Chemistry and Biological Activity (Lawson, L. D. and Bauer, R., eds.), Vol. 691, pp. 176-209, American Chemical Society, Washington (1998)

Mirelman et al, “Inhibition of growth of Entamoeba histolytica by allicin, the active principle of garlic extract (Allium sativum)”, J Infect Dis 156:243-244 (1987)

Mirelman et al, “Immobilized Alliinase and Continuous Production of Allicin”, international patent WO 97/39115, published Oct. 23, 1997

Moore et al, “The fungicidal and fungistatic effects of an aqueous garlic extract on medically important yeast-like fungi”, Mycologia 69:341-348 (1977)

Tansey et al, “Inhibition of fungal growth by garlic extract”, Mycologia 67:409-413 (1975)

What is claimed is

1. A method for sterilization of soil against plant pathogens which comprises administering to the soil an effective amount of allicin prior to seeding and planting.

2. A method according to claim 1, wherein said plant pathogens are selected from the group consisting of fungi, bacteria, protozoa, and soil nematodes.

3. A method according to claim 2, wherein said plant pathogen is a fungus.

4. A method according to claim 3, wherein said plant pathogenic fungus is selected from the group fungi consisting of the genera Sclerotinia, Fusarium, Rhizoctonia, Sclerotium rolfsii and Trichoderma that attack mushroom.

5. A method according to claim 4, wherein said plant pathogenic fungus is of the genera Rhizoctonia.

6. A method according to claim 5, wherein said plant pathogenic fungus is Rhizoctonia solani.

7. A method according to claim 1, wherein said allicin is administered to the soil in an amount of about 15-100 mg/kg soil.

8. A method according to any one of claims 1 to 7, wherein allicin is administered by irrigation.

9. A method according to any one of claims 1 to 7, wherein allicin is administered to the soil in greenhouses.

10. A method for protecting plants against contamination by plant pathogens which comprises seeding or planting the plants in soil that was treated with allicin prior to seeding or planting.

11. A method according to claim 10, wherein the plants are seeded or planted about 8 days after treatment of the soil with allicin.

12. A method according to claim 10 or 11, wherein said plant pathogen is selected from the group consisting of fungi, bacteria, protozoa, and soil nematodes.

13. A method according to claim 12, wherein said plant pathogen is a fungus.

14. A method according to claim 13, wherein said plant pathogenic fungus is selected from the group fungi consisting of the genera Sclerotinia, Fusarium, Rhizoctonia, Sclerotium rolfsii and Trichoderma that attack mushroom.

15. A method according to claim 14, wherein said plant pathogenic fungus is of the genera Rhizoctonia.

16. A method according to claim 15, wherein said plant pathogenic fungus is Rhizoctonia solani.

17. A method according to claim 10, wherein said allicin is administered to the soil in an amount of about 15-100 mg/kg soil.

18. A method according to any one of claims 10 to 17, wherein allicin is administered by irrigation.

19. A method according to any one of claims 10 to 17, wherein the plants are grown in greenhouses.

20. Use of allicin for sterilization of soil against plant pathogens.

21. Use according to claim 20 wherein allicin is administered to the soil prior to seeding and planting.

22. Use according to claim 20 or 21, wherein said plant pathogen is selected from the group consisting of fungi, bacteria, protozoa, and soil nematodes.

23. Use according to claim 22, wherein said plant pathogen is a fungus.

24. Use according to claim 23, wherein said plant pathogenic fungus is selected from the group fungi consisting of the genera Sclerotinia, Fusarium, Rhizoctonia, Sclerotium rolfsii and Trichoderma that attack mushroom.

25. Use according to claim 24, wherein said plant pathogenic fungus is of the genera Rhizoctonia.

26. Use according to claim 25, wherein said plant pathogenic fungus is Rhizoctonia solani.

27. Use according to claim 20, wherein said allicin is administered to the soil in an amount of about 15-100 mg/kg soil.

28. Use according to any one of claims 20 to 27, wherein allicin is administered by irrigation.

29. Use according to any one of claims 20 to 27, wherein allicin is administered to the soil in greenhouses.
